(19) United States
(12) Patent Application Publication
(10) Pub. No.: US 2021/0002136 A1
(43) Pub. Date: Jan. 7, 2021

(54) Method of removing hydrogen peroxide from sulfuric acid

(71) Applicant: Cheng Ming Huang, Kaohsiung (TW)

(72) Inventor: Cheng Ming Huang, Kaohsiung (TW)

(21) Appl. No.: 17/028,989

(22) Filed: Sep. 22, 2020

(51) Int. Cl. C01B 15/022; B01J 23/72; B01J 23/50; B01J 23/06; C01B 15/013

(52) U.S. Cl. CPC C01B 15/022; B01J 23/72; C01B 15/0135; B01J 23/06; B01J 23/50

(57) ABSTRACT

A method of removing hydrogen peroxide from sulfuric acid includes pouring sulfuric acid (H₂SO₄) having 0.1% to 10% of hydrogen peroxide (H₂O₂) into a vessel; adding a catalyst containing metal or metal compound to the vessel to undergo a reaction with the sulfuric acid (H₂SO₄) to remove hydrogen peroxide (H₂O₂) from the sulfuric acid (H₂SO₄), to generate heat, and to generate metal ions in the sulfuric acid (H₂SO₄); activating a cooling device to cool the vessel to a predetermined temperature range; adding sulfur (S²⁻) to the vessel to undergo a reaction with the metal ions to generate metallic sulfide; and purifying the metal free sulfuric acid (H₂SO₄) to obtain the metallic sulfide and highly purified, diluted sulfuric acid (H₂SO₄) as products.

### BACKGROUND OF THE INVENTION

### 1. Field of the Invention

The invention relates to methods of removing hydrogen peroxide from sulfuric acid and more particularly to a method of removing hydrogen peroxide from waste sulfuric acid so that products (e.g., copper (II) sulfide (CuS) of high purity and highly purified, diluted sulfuric acid (H₂SO₄)) can be reused.

### 2. Description of Related Art

Conventionally, sulfuric acid of high purity is used to clean the surface of an etched silicon wafer in a semiconductor manufacturing process. Hydrogen peroxide (H₂O₂) is added to the sulfuric acid (H₂SO₄) to form a strong oxidizing agent which is adapted to oxidize organic substances of the wafer into CO₂ and H₂O. At the end of the process, waste sulfuric acid (H₂SO₄) is generated. The waste sulfuric acid comprises 40%-80% of sulfuric acid (H₂SO₄), 4%-8% of hydrogen peroxide (H₂O₂), and water being the remaining substance in terms of concentration.

However, there are contaminants in the waste sulfuric acid. The hydrogen peroxide (H₂O₂) in the contaminants is a strong oxidizing agent and can limit reusability of the sulfuric acid (H₂SO₄). Thus, the waste sulfuric acid cannot be used again for clean wafers in the semiconductor manufacturing process. Conventionally, the hydrogen peroxide (H₂O₂) is removed from the waste sulfuric acid with other products being generated for reuse in a semiconductor manufacturing company.

Conventionally, there are many methods of removing hydrogen peroxide from waste sulfuric acid. One of the most widely used methods comprises the step of adding hydrochloric acid (HCl) in the waste sulfuric acid to undergo a reaction with the hydrogen peroxide (H₂O₂). It is noted that hydrochloric acid (HCl) is both a reactant and a catalyst. The expression is shown below.

H₂O₂+2HCl→Cl_{2(g)}+2H₂O

The other most widely used method comprises the step of adding activated carbon or enzyme to the waste sulfuric acid to undergo a reaction with the hydrogen peroxide (H₂O₂) for dissolving the hydrogen peroxide (H₂O₂).

The conventional methods of removing hydrogen peroxide from waste sulfuric acid have the following drawbacks: While certain amount of hydrogen peroxide (H₂O₂) can be removed from the waste sulfuric acid by adding hydrochloric acid (HCl) to the waste sulfuric acid, there is diluted sulfuric acid (H₂SO₄) having chlorine ions (Cl⁻) in the final product. The chlorine ions (Cl⁻) can corrode the apparatus used in the method and in turn lower the quality of the products. While enzyme added to the waste sulfuric acid can remove hydrogen peroxide from the waste sulfuric acid, the amount of the hydrogen peroxide is relatively low. Further, the chemical reaction takes a relatively long time, thereby greatly increasing the processing cost.

Thus, the need for improvement still exists.

### SUMMARY OF THE INVENTION

It is therefore one object of the invention to provide a method of removing hydrogen peroxide from sulfuric acid comprising steps of (i) pouring sulfuric acid (H₂SO₄) having 0.1% to 10% of hydrogen peroxide (H₂O₂) into a vessel; (ii) adding a catalyst containing metal or metal compound to the vessel to undergo a reaction with the sulfuric acid (H₂SO₄) to remove hydrogen peroxide (H₂O₂) from the sulfuric acid (H₂SO₄), to generate heat, and to generate metal ions in the sulfuric acid (H₂SO₄); (iii) activating a cooling device to cool the vessel to a predetermined temperature range; (iv) adding sulfur (S²⁻) to the vessel to undergo a reaction with the metal ions to generate metallic sulfide; and (v) purifying the metal free sulfuric acid (H₂SO₄) to obtain the metallic sulfide and highly purified, diluted sulfuric acid (H₂SO₄) as products.

Preferably, in step (ii) the catalyst is copper (Cu).

Preferably, in step (ii) the catalyst is copper compound.

Preferably, in step (ii) the catalyst is silver (Ag).

Preferably, in step (ii) the catalyst is silver compound.

Preferably, in step (ii) the catalyst is mercury (Hg).

Preferably, in step (ii) the catalyst is mercury compound.

Preferably, there is further provided the step of (vi) adding activated carbon to the products after step (v).

Preferably, in step (iv) of adding sulfur (S²⁻) to the vessel, the amount of the sulfur (S²⁻) is controlled by an oxidation reduction potential (ORP) controller.

The invention has the following advantages and benefits in comparison with the conventional art:

The highly purified, diluted sulfuric acid (H₂SO₄) thus can be reused. Particularly, both products, i.e., copper (II) sulfide (CuS) of the high purity and the highly purified, diluted sulfuric acid (H₂SO₄), are adapted to reuse. Still particularly, the highly purified, diluted sulfuric acid (H₂SO₄) finds wide chemical applications. Therefore, the waste sulfuric acid having hydrogen peroxide, after treated by the method of the invention, can be reused in wide applications.

The products are highly reusable. Both products, i.e., copper (II) sulfide (CuS) of the high purity and the highly purified, diluted sulfuric acid (H₂SO₄), are adapted to reuse by removing hydrogen peroxide from the waste sulfuric acid.

Copper ions based catalysts do not generate chlorine ions. The copper ions based catalysts can produce metallic sulfide and highly purified, diluted sulfuric acid without chlorine ions being generated. This ensures the apparatus involved in the method steps to be less liable to corrosion, thereby increasing safety of the method.

The above and other objects, features and advantages of the invention will become apparent from the following detailed description taken with the accompanying drawings.

### BRIEF DESCRIPTION OF THE DRAWINGS

FIG. 1 is a flowchart of a method of removing hydrogen peroxide from sulfuric acid according to the invention;

FIG. 2 is a flowchart illustrating details of FIG. 1; and

FIG. 3 is a table of test reports regarding the invention.

### DETAILED DESCRIPTION OF THE INVENTION

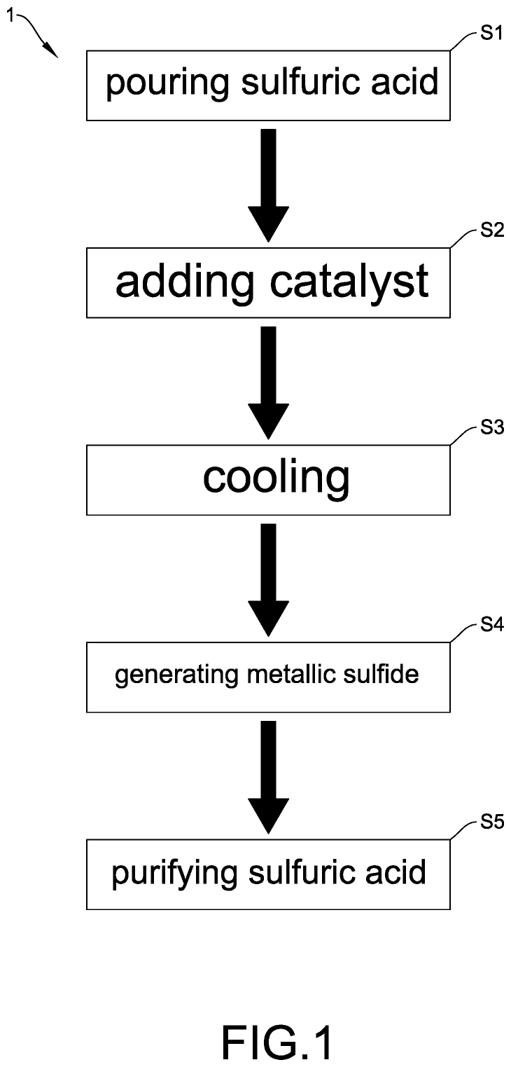

Referring to FIG. 1, a method 1 of removing hydrogen peroxide from sulfuric acid in accordance with the invention is illustrated and comprises the following steps of S1 pouring sulfuric acid (H₂SO₄) having 0.1% to 10% of hydrogen peroxide (H₂O₂) into a vessel; S2 adding a catalyst containing metal or metal compound to the vessel to undergo a reaction to remove hydrogen peroxide (H₂O₂) from the sulfuric acid (H₂SO₄) in which the catalyst is copper or copper compound such as cupric oxide (CuO), copper (II) hydroxide (Cu(OH)₂), copper (II) carbonate (CuCO₃), copper (II) sulfate (CuSO₄), or copper (Cu); silver (Ag) or silver compound; or mercury (Hg) or mercury compound such as cupric oxide (CuO) which is taken as an exemplary catalyst by the invention; S3 cooling the vessel; and S4 removing metal from the hydrogen peroxide free sulfuric acid; and S5 purifying the metal free sulfuric acid (H₂SO₄).

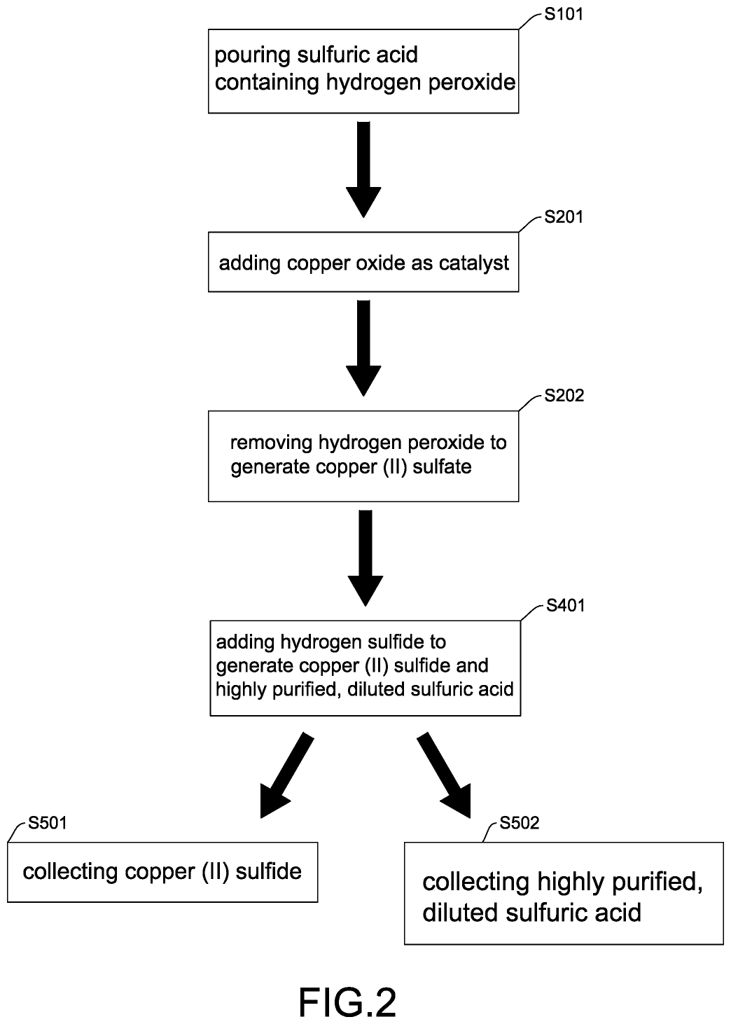

Referring to FIG. 2 in conjunction with FIG. 1, details of the flowchart are illustrated below.

In step S101, sulfuric acid (H₂SO₄) having 0.1% to 10% of hydrogen peroxide (H₂O₂) is poured into the vessel.

In step S201, cupric oxide (CuO) is added to the vessel to undergo a reaction to dissolve hydrogen peroxide (H₂O₂) to form copper (II) sulfate (CuSO₄) in which the amount of cupric oxide (CuO) is adjusted based on a concentration percentage of hydrogen peroxide in sulfuric acid until hydrogen peroxide (H₂O₂) is completely dissolved and removed with no products being produced except meal ions and sulfuric acid (H₂SO₄). Expressions of step S201 are below.

CuO₍ₛ₎+H₂SO₄₍ₗ₎→CuSO₄₍ₗ₎+H₂O₍ₗ₎

2H₂O₂₍ₗ₎^{Cu2+}_{→}2H₂O₍ₗ₎+O_{2(g)}

Great heat is generated when sulfuric acid (H₂SO₄) undergoes a chain reaction with the catalyst (e.g., cupric oxide (CuO)). The heat generation process continues until the materials involved in the reaction are consumed. This is very dangerous because the vessel and associated devices can be damaged or even causes explosion. Thus, a cooling device is activated to cool the vessel to 60° C.-90° C. step S3 so that the method 1 can be performed successfully.

In step S3, sulfuric acid (H₂SO₄) undergoes a chain reaction with the catalyst (e.g., cupric oxide (CuO)) to generate metal ions in sulfuric acid (H₂SO₄), i.e., the generation of copper (II) sulfate (CuSO₄). Thus, in step S4 of removing metal from the hydrogen peroxide free sulfuric acid there is further provided step S401 of adding sulfur (S²⁻) (e.g., hydrogen sulfide (H2S)) to the vessel to undergo a reaction with copper (II) sulfate (CuSO₄) to generate copper (II) sulfide (CuS) which is capable of removing copper ions (Cu⁺) in copper (II) sulfate (CuSO₄). Expressions of step S401 are below.

H₂S_{(g)}+CuSO₄₍ₗ₎→CuS₍ₛ₎⬇+H₂SO₄₍ₗ₎

In step S5 of purifying the metal free sulfuric acid (H₂SO₄) to obtain the metallic sulfide and the highly purified, diluted sulfuric acid (H₂SO₄), there are further provided step S501 of collecting copper (II) sulfide (CuS) of the high purity of the step S401 for further use; and step S502 of collecting the highly purified, diluted sulfuric acid (H₂SO₄) for further use. In detail, copper (II) sulfide (CuS) of the high purity can be used as an agent for experiments, and the highly purified, diluted sulfuric acid (H₂SO₄) can be used as a material for chemical processing, i.e., used reused after treatment.

Preferably, activated carbon is added to the products produced by step S5 for absorbing smell.

In step S401 of adding sulfur (S²⁻) (e.g., sodium hydrosulfide (NaHS), Sodium sulfide (Na₂S), organic sulfur or hydrogen sulfide (H₂S) which is used by the invention) to the vessel, the amount of hydrogen sulfide (H₂S) is controlled by an oxidation reduction potential (ORP) controller. Further, it ensures the generation of metal ions in sulfuric acid (H₂SO₄), i.e., the generation of copper (II) sulfate (CuSO₄) of quality.

No chlorine ions are generated by the method of the invention when the products (i.e., copper (II) sulfide (CuS) of the high purity and the highly purified, diluted sulfuric acid (H₂SO₄)) are produced. This ensures that the quality products of hydrogen peroxide free are useful for further uses and applications. Particularly, the highly purified, diluted sulfuric acid (H₂SO₄) finds wide chemical applications.

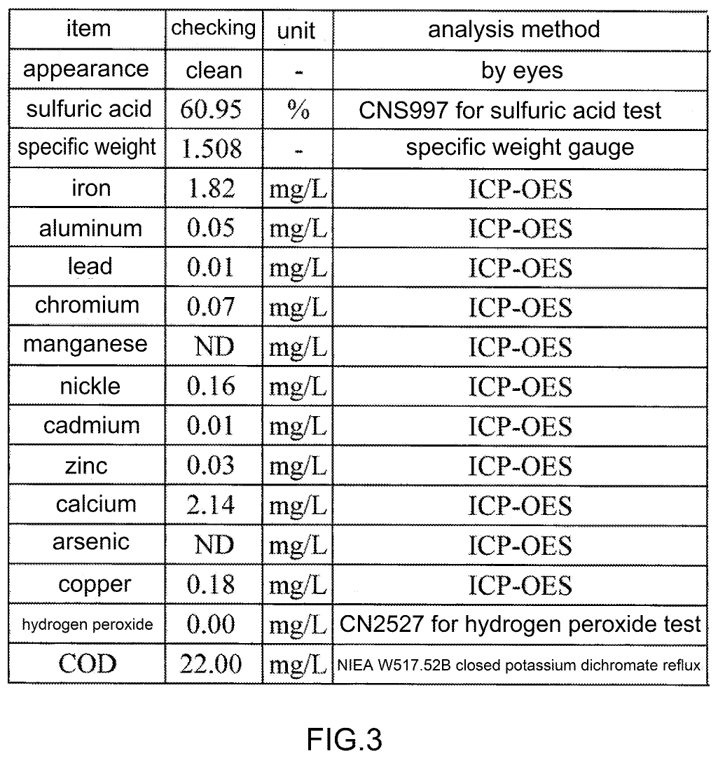

Referring to FIG. 3, it shows a table of test reports regarding the invention. It is found that hydrogen peroxide is substantially removed from the highly purified, diluted sulfuric acid (H₂SO₄) thus can be reused.

The invention has the following advantages and benefits in comparison with the conventional art:

The highly purified, diluted sulfuric acid (H₂SO₄) thus can be reused. Particularly, both products, i.e., copper (II) sulfide (CuS) of the high purity and the highly purified, diluted sulfuric acid (H₂SO₄), are adapted to reuse. Still particularly, the highly purified, diluted sulfuric acid (H₂SO₄) finds wide chemical applications. Therefore, the waste sulfuric acid having hydrogen peroxide, after treated by the method of the invention, can be reused in wide applications.

The products are highly reusable. Both products, i.e., copper (II) sulfide (CuS) of the high purity and the highly purified, diluted sulfuric acid (H₂SO₄), are adapted to reuse by removing hydrogen peroxide from the waste sulfuric acid.

Copper ions based catalysts do not generate chlorine ions. The copper ions based catalysts can produce metallic sulfide and highly purified, diluted sulfuric acid without chlorine ions being generated. This ensures the apparatus involved in the method steps to be less liable to corrosion, thereby increasing safety of the method.

While the invention has been described in terms of preferred embodiments, those skilled in the art will recognize that the invention can be practiced with modifications within the spirit and scope of the appended claims.

What is claimed is:

1. A method of removing hydrogen peroxide from sulfuric acid, comprising the steps of:
(i) pouring sulfuric acid (H₂SO₄) having 0.1% to 10% of hydrogen peroxide (H₂O₂) into a vessel;
(ii) adding a catalyst containing metal or metal compound to the vessel to undergo a reaction with the sulfuric acid (H₂SO₄) to remove hydrogen peroxide (H₂O₂) from the sulfuric acid (H₂SO₄), to generate heat, and to generate metal ions in the sulfuric acid (H₂SO₄);
(iii) activating a cooling device to cool the vessel to a predetermined temperature range;
(iv) adding sulfur (S²⁻) to the vessel to undergo a reaction with the metal ions to generate metallic sulfide; and
(v) purifying the metal free sulfuric acid (H₂SO₄) to obtain the metallic sulfide and highly purified, diluted sulfuric acid (H₂SO₄) as products.

2. The method of removing hydrogen peroxide from sulfuric acid of claim 1, wherein in step (ii) the catalyst is copper (Cu).

3. The method of removing hydrogen peroxide from sulfuric acid of claim 1, wherein in step (ii) the catalyst is copper compound.

4. The method of removing hydrogen peroxide from sulfuric acid of claim 1, wherein in step (ii) the catalyst is silver (Ag).

5. The method of removing hydrogen peroxide from sulfuric acid of claim 1, wherein in step (ii) the catalyst is silver compound.

6. The method of removing hydrogen peroxide from sulfuric acid of claim 1, wherein in step (ii) the catalyst is mercury (Hg).

7. The method of removing hydrogen peroxide from sulfuric acid of claim 1, wherein in step (ii) the catalyst is mercury compound.

8. The method of removing hydrogen peroxide from sulfuric acid of claim 1, further comprising the step of (vi) adding activated carbon to the products after step (v).

9. The method of removing hydrogen peroxide from sulfuric acid of claim 1, wherein in step (iv) of adding sulfur (S²⁻) to the vessel, the amount of the sulfur (S²⁻) is controlled by an oxidation reduction potential (ORP) controller.
